(19) United States
(12) Patent Application Publication
(10) Pub. No.: US 2023/0087982 A1
(43) Pub. Date: Mar. 23, 2023

(54) SIGNAL PROCESSING APPARATUS, SIGNAL PROCESSING METHOD, AND PROGRAM

(71) Applicant: NIPPON TELEGRAPH AND TELEPHONE CORPORATION, Tokyo (JP)

(72) Inventors: Rintaro IKESHITA, Tokyo (JP); Tomohiro NAKATANI, Tokyo (JP); Shoko ARAKI, Tokyo (JP)

(73) Assignee: NIPPON TELEGRAPH AND TELEPHONE CORPORATION, Tokyo (JP)

(21) Appl. No.: 17/802,090

(22) PCT Filed: Feb. 26, 2020
(86) PCT No.: PCT/JP2020/007643

§ 371 Date: Aug. 24, 2022

(51) Int. Cl. G10L 21/028; G10L 25/21; G10L 21/0224

(52) U.S. Cl. CPC G10L 21/028; G10L 25/21; G10L 21/0224; G10L 2021/02082

(57) ABSTRACT

A signal processing device applies a convolutional separation filter, which is a combined filter of: a rear reverberation removal filter for suppressing a rear reverberation component from a mixed acoustic signal obtained by converting an observed mixed acoustic signal obtained by observing a source signal into a time-frequency domain; and a sound source separation filter for emphasizing components corresponding to source signals from the mixed acoustic signal, to a mixed acoustic signal string including the mixed acoustic signal and a delay signal of the mixed acoustic signal and estimates model parameters of a model for obtaining information corresponding to signals in which the rear reverberation component is suppressed and target signals emitted from target sound sources in the source signal are emphasized.

### TECHNICAL FIELD

The present invention relates to a sound source extraction technique.

### BACKGROUND ART

A sound source extraction technique for estimating source signals of sound sources in which noise and reverberation are suppressed, by taking, as an input, an observed mixed acoustic signal, is a technique widely used for, for example, preprocessing of sound recognition. As a method of performing sound source extraction using a mixed acoustic signal observed using a plurality of microphones, an independent vector analysis (IVA) has been known, which corresponds to multivariate expansion of an independent component analysis.

It is known that, when the IVA is used in a real environment, performance is deteriorated because of the influence of background noise and reverberation. Concerning the background noise, a problem is that increasing the number of microphones M larger than the number of target sound sources K also increases a processing time although robustness of the IVA can be improved. As a method of suppressing an increase in processing speed and performing sound source at high speed even when the number of microphones M is larger than the number of sound sources K, an Over IVA (see, for example, Non-Patent Literature 1) has been known.

### CITATION LIST

### Non-Patent Literature

Non-Patent Literature 1: Robin Scheibler and Nobutaka Ono, “Independent vector analysis with more microphones than sources,” in Proc. WASPAA, 2019.

### SUMMARY OF THE INVENTION

### Technical Problem

With the Over IVA, it is possible to perform sound source extraction robust against background noise. However, since reverberation is not considered in the Over IVA, the problem of the performance deterioration involved in the reverberation is still present.

An object of the present invention, which has been made in view of such a point, is to provide a signal processing technique for performing, at high speed, sound extraction robust against reverberation in addition to noise.

### Means for Solving the Problem

A signal processing device applies a convolutional separation filter, which is a combined filter of: a rear reverberation removal filter for suppressing a rear reverberation component from a mixed acoustic signal obtained by converting an observed mixed acoustic signal obtained by observing a source signal into a time-frequency domain; and a sound source separation filter for emphasizing components corresponding to source signals from the mixed acoustic signal, to a mixed acoustic signal string including the mixed acoustic signal and a delay signal of the mixed acoustic signal and estimates model parameters of a model for obtaining information corresponding to signals in which the rear reverberation component is suppressed and target signals emitted from target sound sources in the source signal are emphasized.

### Effects of the Invention

Since the convolutional separation filter is the combined filter of the rear reverberation removal filter and the sound source separation filter, in the present invention, it is possible to perform, at high speed, sound source extraction robust against reverberation in addition to noise.

### BRIEF DESCRIPTION OF DRAWINGS

FIG. 1 is a block diagram illustrating a functional configuration of a signal processing device in an embodiment.

FIG. 2 is a block diagram illustrating a functional configuration of a convolutional-separation-filter estimation unit in a first embodiment.

FIG. 3 is a flowchart for illustrating a signal processing method in the embodiment.

FIG. 4 is a flowchart for illustrating processing in step S13 in FIG. 3.

FIG. 5 is a block diagram illustrating a functional configuration of a convolutional-separation-filter estimation unit in a second embodiment.

FIG. 6 is a flowchart for illustrating processing in step S23 in FIG. 3.

FIG. 7 is a block diagram illustrating a configuration in the case in which the signal processing device in the embodiment is used for signal extraction.

FIG. 8 is a block diagram illustrating a hardware configuration of the signal processing device in the embodiment.

### DESCRIPTION OF EMBODIMENTS

An embodiment of the present invention is explained below.

### [Principle]

First, a principle is explained.

### <Blind Sound Source Extraction Problem>

First, a blind sound source extraction problem is defined. It is assumed that, in a state in which target signals (for example, sound signals) emitted from K target sound sources and noise signals emitted from M−K noise sources propagate in air and mixed, the target signals and the noise signals are observed by M microphones. Signals obtained by observing, with the M microphones, source signals emitted from the M sound sources (the target sound sources and the noise sound sources) are referred to as observed mixed acoustic signals. These source signals include the target signals emitted from the K target sound sources and the noise signals emitted from the M−K noise sources. M is an integer equal to or larger than 2, K is an integer equal to or larger than 1, and 1≤K≤M−1. It is assumed that the target signals are unsteady and the noise signals are steady Gaussian noise. Among mixed acoustic signals in M dimensions obtained by converting the observed mixed acoustic signals observed by the M microphones into a time-frequency (TF) domain (for example, short-time Fourier transform), a component corresponding to a k-th (k∈{1, . . . , K}) target signal is represented as xₖ(f, t) ∈C^{M}. C represents a set of entire complex numbers, C^{α} represents an entire set of α-dimensional vectors consisting of complex number elements, and α∈β represents that α belongs to β. That is, a component corresponding to the target signal among the mixed acoustic signals of the M dimensions is x₁(f, t), x_{K}(f, t)∈C^{M}. Among the mixed acoustic signals of the M dimensions, a mixed acoustic signal component corresponding to a z-th (z∈{K+1, . . . , M}) target signal is represented as x_{z}(f, t)∈C^{M}. Then, the mixed acoustic signals of the M dimensions are represented by the following Expression (1).

[Math. 1]

X(f,t):Eₖ₌₁^{K}xₖ(f,t)+x_{z}(f,t)∈C^{M} (1)

where, f∈{1, . . . , F} and t∈{1, . . . , T} are respectively indexes of a frequency bin and a time frame (indexes of a discrete frequency and a discrete time). F and T are positive integers. α:=β means that α is defined as β.

In the following explanation, considering the influence of reverberation, a mixed acoustic signal component xᵢ(f, t) of sound sources i∈{1, . . . , K, z} can be decomposed into a sum dᵢ(f, t)∈C^{M} of a direct sound component and an initial reflection component and a rear reverberation component rᵢ(f, t)∈C^{M}. It is assumed that dᵢ(f, t) follows the a space model described below.

xᵢ(f,t)=dᵢ(f,t)+rᵢ(f,t),i∈{1, . . . ,K,z} (2)

dₖ(f,t)=aₖ(f)sₖ(f,t)∈C^{M},k∈{1, . . . ,K} (3)

d_{z}(f,t)=A_{z}(f)z(f,t)∈C^{M} (4)

aₖ(f)∈C^{M},sₖ(f,t)∈C,k∈{1, . . . ,K} (5)

A_{z}(f)∈C^{Mx(M-K)},z(f,t)∈C^{M-K} (6)

where, aₖ(f) and sₖ(f, t) are respectively a transfer function and a source signal (a target signal) of a target sound source k and A_{z}(f) and z(f, t) are respectively matrix representation of transfer functions and source signals of M−K noise sources. A problem of estimating x₁(f, t), . . . , x_{K}(f, t) only from an observed signal under an assumption that sound sources are independent from one another is known as a blind source separation problem. In contrast, the blind sound source extraction problem treated in this embodiment is defined as a problem of estimating d₁ (f, t), . . . , dₖ (f, t) to which reverberation removal is also applied in addition to sound source separation. The number of target sound sources K is known.

<Probability Model of IVEconv>

A sum of sound source signals after removing a rear reverberation component from a mixed acoustic signal x(f, t) is put as indicated by Expression (7).

[Math. 2]

d(f,t):=Σₖ₌₁^{K}dₖ(f,t)+d_{z}(f,t) (7)

A probability model of IVEconv is defined below using a hyper parameter Δ⊏N. N represents a set of entire natural numbers and α⊏β represents that a is a subset of β.

[Math. 3]

d(f,t)=x(f,t)−Σ_{τ∈Δ}Q_{τ}(f)x(f,t−τ) (8)

sₖ(f,t)=wₖ(f)^{H}d(f,t)∈C,k∈{1, . . . ,K} (9)

z(f,t)=W_{z}(f)^{H}d(f,t)∈C^{M-K} (10)

sₖ(t):=[sₖ(1,t), . . . ,sₖ(F,t)]^{T}∈C^{F} (11)

sₖ(t)˜CN(0_{F}λₖ(t)I_{F})k∈{1, . . . ,K} (12)

z(f,t)˜CN(0_{M-K},I_{M-K}) (13)

[Math. 4]

p({sₖ(t),z(f,t)}_{k,f,t})=Π_{k,t}sₖ(t)·Π_{f,t}z(f,t) (14)

where, α^{T} is transposition of α, α^{H} is Hermitian transposition of α, λ(t) is a power spectrum of sₖ(t), CN(μ, Σ) is a complex normal distribution of a distributed covariance matrix Σ in an average vector μ, I_{α} is a unit matrix of α×α, 0_{α}, is an α-dimensional vector, all elements of which are 0, β-CN(μ, Σ) represents that β conforms to the complex normal distribution CN(μ, Σ), p(α) is a probability of α, wₖ(f) is a sound source separation filter for emphasizing a component corresponding to a target signal emitted from a k-th target sound source, and W_{z}(f) is a sound source separation filter for emphasizing a component corresponding to a noise signal emitted from a z-th noise source.

Model parameters of the probability model of IVEconv are the following four:

Rear reverberation removal filter: Q_{δ}(f) ∈C^{M×M}, δ∈Δ
Sound source separation filter of a target signal: wₖ(f) ∈C^{M}
Power spectrum of the target signal: λₖ(t)∈R_{≥0}
Sound source separation filter of a noise signal: W_{z}(f) ∈C^{M×(M-K)}

R_{≥0} means a set of entire real numbers equal to or larger than 0.

<Simplification of the Probability Model of IVEconv>

In the model described above, since the reverberation removal filter and the sound source separation filter are generally alternately optimized, it is likely that a result of the optimization tends to fall into a localized solution. Therefore, in this embodiment, the reverberation removal filter and the sound source separation filter, which are the model parameters of the probability model of IVEconv, are converted into one filter obtained by combining both the filters to rewrite the probability model of IVEconv into a simple model. An element of a hyper parameter Δ is represented by Δ={τ₁, . . . , τ_{|Δ|}}. Δ∈{τ₁, . . . , τ_{|Δ|}} and |Δ| is a positive integer representing the number of elements of the hyper parameter Δ. There are the following definitions.

$$\begin{matrix}[ Math . 5 ] & \\ Q ( f ) : = [ \begin{matrix}{I}_{m} \\ - {Q}_{{τ}_{1}} ( f ) \\ ⋮ \\ - {Q}_{{τ}_{\vert Δ \vert}} ( f )\end{matrix} ] & ( 14 a )\end{matrix}$$

$$\begin{matrix}[ Math . 6 ] & \\ \hat{x} ( f , t ) : = [ \begin{matrix}x ( f , t ) \\ x ( f , t - {τ}_{1} ) \\ ⋮ \\ x ( f , t - {τ}_{\vert Δ \vert} )\end{matrix} ] & ( 14 b )\end{matrix}$$

where, Q_{δ}(f) is a rear reverberation removal filter and x\hat{ }(f, t) is referred to as mixed acoustic signal string. Note that the superscript “\hat{ }” of x\hat{ }(f, t) should originally be described immediately on “x” but is sometimes described above right of “x” like x\hat{ }(f, t) because of limitation of description. At this time, a set of Q(f) and W(f)=[w₁(f), . . . , w_{K}(f), W_{z}(f)] is converted into the following Expression (17) one to one according to the following Expressions (15) and (16).

pₖ(f)=Q(f)wₖ(f)∈C^{M(|Δ|+1)} (15)

P_{z}(f)=Q(f)W_{z}(f)∈c^{M(|Δ|+1)×(M-K)} (16)

P(f)=[p₁(f), . . . ,p_{K}(f),P_{z}(f)] (17)

where, C^{α×β} represents an entire set of an α×β matrix consisting of complex number elements and pₖ(f)=Q(f)wₖ(f) is a convolutional separation filter component corresponding to a target signal emitted from a k-th target sound source. P_{z}(f)=Q(f)W_{z}(f) is a convolutional separation filter component corresponding to a noise signal emitted from a z-th noise source.

In this embodiment, a filter P(f) that simultaneously achieves rear reverberation removal and sound source separation is referred to as convolutional separation filter. That is, the convolutional separation filter is a combined filter of a rear reverberation removal filter Q(f) for suppressing a rear reverberation component from the mixed acoustic signal x(f, t) and a sound source separation filter W(f) for emphasizing components corresponding to source signals from the mixed acoustic signal x(f, t). According to this conversion, Expressions (8) to (10) are converted like the following Expressions (18) and (19).

[Math. 7]

Sₖ(f,t)=pₖ(f)^{H}\hat{x}(f,t)∈C,K∈{1, . . . ,K} (18)

[Math. 8]

z(f,t)=P_{z}(f)^{H}\hat{x}(f,t)∈C^{M-K} (19)

Consequently, the probability model of IVEconv is organized as Expressions (11) to (14) and (18) to (19). This probability model is a model for applying the convolutional separation filter P(f) to a mixed acoustic signal string x\hat{ }(f, t) including a mixed acoustic signal x(f, t) and a delay signal x(f, t−τ₁), . . . , x(f, t−τ_{|Δ|}) of the mixed acoustic signal explained below and obtaining information corresponding to signals in which a rear reverberation component is suppressed and target signals sₖ(f, t) emitted from target sound sources among source signals are emphasized. The mixed acoustic signal x(f, t) is a signal obtained by converting an observed mixed acoustic signal obtained by observing a source signal into a time-frequency domain. The convolutional separation filter P(f) is a combined filter of a rear reverberation removal filter Q_{δ}(f) for suppressing a rear reverberation component from the mixed acoustic signal x(f, t) and a sound source separation filter W(f) for emphasizing components corresponding to source signals from the mixed acoustic signal x(f, t). Model parameters of this model are the convolutional separation filter P(f) of Expression (17) and the power spectrum λₖ(t) of the target signal of Expression (12).

<Optimization of the Simplified Probability Model of IVEconv>

Model parameters of the simplified probability model of IVEconv can be estimated by a maximum likelihood method. This is achieved by minimizing a target function J, which is negative log likelihood, represented by the following Expression (20).

$$\begin{matrix}[ Math . 9 ] & \\ J = {\sum }_{k , t} [ \frac{{‖ {s}_{k} ( t ) ‖}^{2}}{{λ}_{k} ( t )} + F \cdot log {λ}_{k} ( t ) ] + {\sum }_{f , t} {\vert z ( f , t ) \vert}^{2} - 2 T {\sum }_{f} log \vert det W ( f ) \vert + const . & ( 20 )\end{matrix}$$

where, |α| is the absolute value of α, ∥α∥ is a norm of α, det(α) is a determinant of α, and “const.” is a constant not depending on parameters. First M row components of the convolutional separation filter P(f) is W(f)=[w₁ (f), . . . , w_{K} (f), W_{z}(f)].

In this embodiment, the convolutional separation filter P(f) and the power spectrum λₖ(t) of the target signal sₖ(f, t) are alternately optimized. If the convolutional separation filter P(f) is fixed, a global optimal solution of the power spectrum λₖ(t) is as follows:

$$\begin{matrix}[ Math . 10 ] & \\ {λ}_{k} ( t ) = \frac{1}{F} {‖ {s}_{k} ( t ) ‖}^{2} & ( 21 )\end{matrix}$$

Accordingly, in power spectrum estimation, the power spectrum λₖ(t) of the target signals sₖ(f, t) is estimated according to Expression (21) with convolutional separation filter P(f) fixed.

When the power spectrum λₖ(t) of the target signal sₖ(f, t) is fixed, a problem of optimizing the convolutional separation filter P(f) to optimize (minimize) the negative target function J can be divided into F problems of minimizing the target function J about convolutional separation filters P(1), . . . , P(F) of frequency bins. A problem of minimizing the target function J about the convolutional separation filter P(f) is represented as follows:

$$\begin{matrix}[ Math . 11 ] & \\ {minimize}_{P ( f )} {J}_{P ( f )} & ( 22 )\end{matrix}$$

where, the following is satisfied.

[Math. 12]

∫_{P(f)}=Σₖ₌₁^{K}Pₖ^{H}(f)Gₖ(f)Pₖ(f)+tr(P_{z}^{H}(f)G_{z}(f)P_{z}(f))−2 log|detW(f)|

where, tr(α) is a diagonal partial sum of α.

$$\begin{matrix}[ Math . 13 ] & \\ {G}_{k} ( f ) = \frac{1}{T} {\sum }_{t = 1}^{T} \frac{\hat{x} ( t , f ) {\hat{x} ( t , f )}^{H}}{{λ}_{k} ( t , f )} ∈ {C}^{M \times M} , k ∈ \{ 1 , … , K \} & ( 23 )\end{matrix}$$

$$\begin{matrix}[ Math . 14 ] & \\ {G}_{z} ( f ) = \frac{1}{T} {\sum }_{t = 1}^{T} \hat{x} ( t , f ) {\hat{x} ( t , f )}^{H} \\ ∈ {C}^{M \times M} & ( 24 )\end{matrix}$$

G_{z} is a covariance matrix of the mixed acoustic signal string x\hat{ }(f, t). Gₖ can be grasped as a noise covariant matrix at the time when a signal other than the target signal sₖ(f, t) is regarded as a noise signal. As explained above, in the convolutional separation filter estimation, a convolutional separation filter P(f) for optimizing a target function J_{p(f)} for a mixed acoustic signal at frequencies is estimated for each of the frequencies with the power spectrum λₖ(t) of the target signals sₖ(f, t) fixed.

The processing of the power spectrum estimation and the processing of the convolutional separation filter estimation explained above are alternately executed until a predetermined condition is satisfied.

### First Embodiment

A first embodiment is explained with reference to the drawings.

### [Configuration]

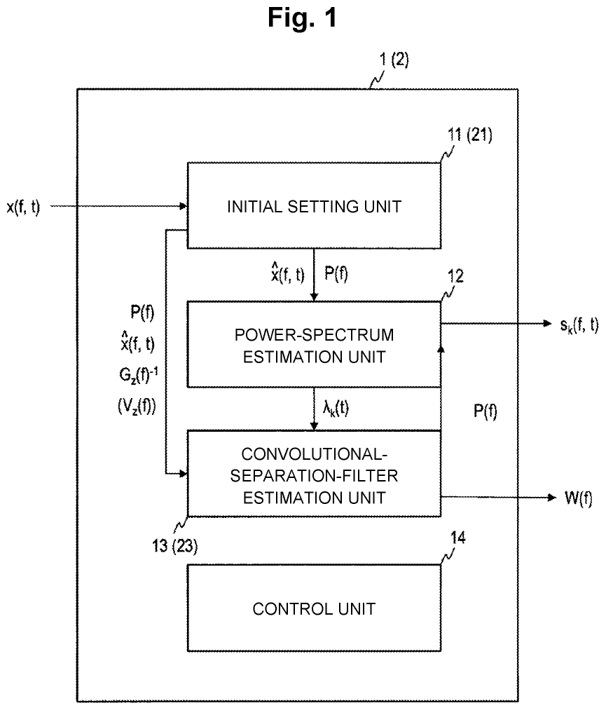

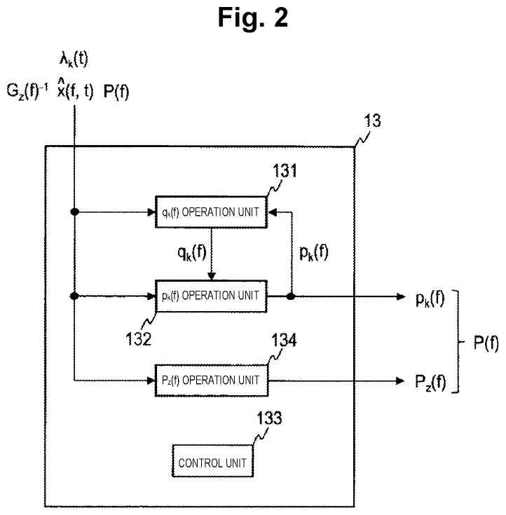

As shown in FIG. 1, a signal processing device 1 in the first embodiment includes an initial setting unit 11, a power-spectrum estimation unit 12, a convolutional-separation-filter estimation unit 13, and a control unit 14. The signal processing device 1 executes respective kinds of processing under control by the control unit 14. As illustrated in FIG. 2, the convolutional-separation-filter estimation unit 13 in the first embodiment includes a qₖ(f) operation unit 131, a pₖ(f) operation unit 132, a P_{z}(f) operation unit 134, and a control unit 133. The convolutional-separation-filter estimation unit 13 executes respective kinds of processing under control by the control unit 133.

<Processing>

As explained above, the signal processing device 1 estimates model parameters of a model for applying the convolutional separation filter P(f), which is a combined filter of: a rear reverberation removal filter Q_{δ}(f) for suppressing a rear reverberation component from a mixed acoustic signal x(f, t) obtained by converting an observed mixed acoustic signal obtained by observing a source signal into a time-frequency domain; and a sound source separation filter W(f) for emphasizing components corresponding to source signals from the mixed acoustic signal x(f, t), to a mixed acoustic signal string x(f, t) including a mixed acoustic signal x(f, t) and a delay signal x(f, t−τ₁), . . . , x(f, t-τ_{|Δ|}) of the mixed acoustic signal and obtaining information corresponding to signals in which a rear reverberation component is suppressed and target signals sₖ(f, t) emitted from target sound sources among source signals are emphasized. Processing is explained in detail below.

<<Processing of the Initial Setting Unit 11 (Step S11)>>

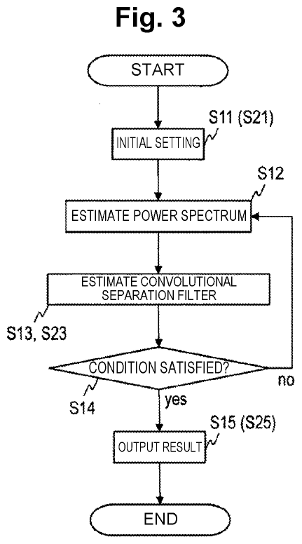

As illustrated in FIG. 3, a mixed acoustic signal x(f, t) (f∈{1, . . . , F}, t∈{1, . . . , T}) is input to the initial setting unit 11 of the signal processing device 1. The initial setting unit 11 sets, about all f, any initial values in the separation filter P(f). For example, the initial setting unit 11 sets P(f)=[I_{M}|O_{M×L}]^{T}. L:=|Δ|M. The initial setting unit 11 calculates x\hat{ }(f, t) according to Expression (14b). Further, the initial setting unit 11 calculates, about all f, G_{z}(f) according to Expression (24). Further, the initial setting unit 11 calculates, about all f, G_{z}(f)⁻¹∈C^{(m+L)×(m+L)} according to Expression (24). The initial setting unit 11 outputs x\hat{ }(f, t) and P(f) to the power-spectrum estimation unit 12 and outputs x\hat{ }(f, t), P(f), and G_{z}(f)⁻¹ to the convolutional-separation-filter estimation unit 13 (step S11).

<<Processing of the Power-Spectrum Estimation Unit 12 (Step S12)>>

The power-spectrum estimation unit 12 uses x\hat{ }(f, t) and P(f)=[p₁(f), . . . , P_{K}(f), P_{z}(f)], obtains, about all f and t, a target signal sₖ(f, t) according to Expression (18), and further obtains a power spectrum λₖ(t) of the target signal sₖ(f, t) according to Expressions (11) and (21). That is, the power-spectrum estimation unit 12 estimates the power spectrum λₖ(t) of target signals sₖ(f, t) with the convolutional separation filter P(f) fixed. The power-spectrum estimation unit 12 outputs the power spectrum λₖ(t) to the convolutional-separation-filter estimation unit 13 (step S12).

<<Processing of the Convolutional-Separation-Filter Estimation Unit 13 (Step S13)>>

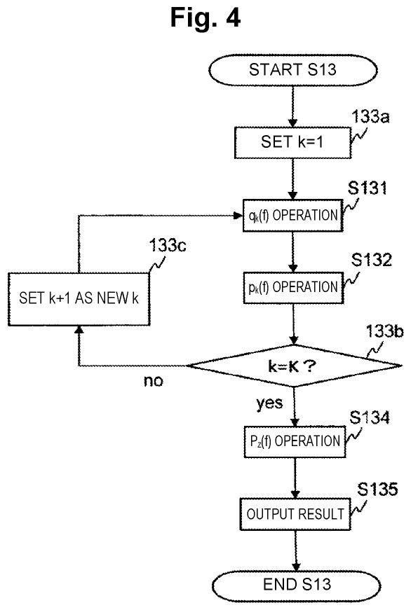

The convolutional-separation-filter estimation unit 13 estimates, with the power spectrum λₖ(t) of the target signals sₖ(f, t) fixed, for each of frequencies, a convolutional separation filter P(f) for optimizing (minimizing) a target function J_{p(f)} (Expression (22)) for the mixed acoustic signal xₖ(f, t) at the frequencies (f∈{1, . . . , F}). This is equivalent to solving a problem of minimizing the target function J about the convolutional separation filter P(f) in frequency bins f=1, . . . , F. For example, as illustrated in FIG. 4, the convolutional-separation-filter estimation unit 13 updates P(f) about all f. The updated P(f) is output to the power-spectrum estimation unit 12.

Update processing of P(f) (FIG. 4):

First, the control unit 133 sets k=1 (step S133a).

Subsequently, the qₖ(f) operation unit takes P(f) and G_{z}(f)⁻¹ as an input and obtains, about all f, qₖ(f) according to Expression (25) and output qₖ(f).

[Math. 15]

qₖ(f)Gₖ(f)⁻¹(^{W(f)-H}^{ₑ}^{ₖ}⁰^{^{L}}) (25)

where, as explained above, a first M row component of P(f) is W(f)=[w₁(f), . . . , W_{K}(f), W_{z}(f)], eₖ is an M-dimensional unit vector, a k-th component of which is 1, and α^{-H} is Hermitian transposition of an inverse matrix of α (step S131).

The pₖ(f) operation unit 132 takes qₖ(f), x\hat{ }(f, t), and λₖ(t) as an input and obtains, about all f, pₖ(f) according to Expressions (23) and (26) and outputs pₖ(f) (step S132).

$$\begin{matrix}[ Math . 16 ] & \\ {p}_{k} ( f ) = {q}_{k} ( f ) {( {{q}_{k} ( f )}^{H} {G}_{k} ( f ) {q}_{k} ( f ) )}^{- \frac{1}{2}} & ( 26 )\end{matrix}$$

The control unit 133 determines whether k=K (step S133). When not k=K, the control unit 133 sets k+1 as new k (step S133c) and returns the processing to step S131. On the other hand, when k=K, the P_{z}(f) operation unit 134 takes G^{z}(f)⁻¹ and pₖ(f) as an input and obtains, about all f, P_{z}(f) according to Expression (27) and outputs P_{z}(f).

$$\begin{matrix}[ Math . 17 ] & \\ {P}_{z} ( f ) = {{G}_{z} ( f )}^{- 1} ( \begin{matrix}{( {{W}_{s} ( f )}^{H} {E}_{s} )}^{- 1} ( {{W}_{s} ( f )}^{H} {E}_{z} ) \\ - {l}_{M - K} \\ {O}_{L \times ( M - K )}\end{matrix} ) & ( 27 )\end{matrix}$$

where, eₖ is an M-dimensional unit vector, a k-th component of which is 1, E_{z}:=[e_{K+1}, . . . , e_{M}]∈C^{M×(M-K)}, Eₛ:=[e₁, . . . , e_{K}]∈C^{M×K}, Wₛ (f):=[w₁(f), . . . , w_{K}(f)]∈C^{M×K}, and 0_{α×β} is an α×β matrix, all elements of which is 0. As explained above, a first M row component of P(f) is W(f)=[w₁(f), . . . , w_{K}(f), W_{z}(f)] (step S134).

The pₖ(f) operation unit 132 outputs pₖ(f) about all k and f. The P_{z}(f) operation unit 134 outputs P^{z}(f) about all z and f. That is, the convolutional-separation-filter estimation unit 13 outputs an optimized convolutional separation filter P(f)=[p₁(f), . . . , p_{K}(f), P_{z}(f)]. Further, the convolutional-separation-filter estimation unit 13 may normalize P(f) after update as explained below and output P(f) after the normalization.

$${c}_{k} ( f ) = \frac{1}{T} {\sum }_{t} {λ}_{k} ( t ) \qquad [ Math . 18 ]$$

$${λ}_{k} ( t ) := {λ}_{k} ( t ) {{c}_{k} ( f )}^{- 1} \qquad [ Math . 19 ]$$

$${p}_{k} ( f ) := {p}_{k} ( f ) {{c}_{k} ( f )}^{- 1 / 2} \qquad [ Math . 20 ]$$

Consequently, it is possible to improve numerical stability. However, this normalization is not essential and may not be performed (step S135).

As explained above, the convolutional-separation-filter estimation unit 13 solves the problem of Expression (22) as shown in FIG. 4 and outputs the optimized convolutional separation filter P(f). At this time, since it is unnecessary to separate and extract a noise signal, in FIG. 4, a high-speed sound source extracting method is realized by adopting a method of optimizing up to a linear space Im(P_{z}) defined by P_{z} instead of strictly optimizing the convolutional separation filter P_{z} for the noise signal.

<<Processing of the Control Unit 14 (Step S14)>>

The control unit 14 determines whether a predetermined condition is satisfied. An example of the predetermined condition is that, for example, the number of times of repetition of the processing of the power spectrum estimation (step S12) and the convolutional separation filter estimation (step S13) reaches a predetermined number of times of repetition or an update amount of model parameters is equal to or smaller than a predetermine threshold. When the predetermined condition is not satisfied, the control unit 14 returns the processing to step S12. On the other hand, when the predetermined condition is satisfied, the control unit 14 advances the processing to step S15. That is, the control unit 14 alternately executes the processing of the power-spectrum estimation unit 12 and processing of the convolutional-separation-filter estimation unit 13 until the predetermined condition is satisfied (step S14).

In step S15, about all f and k, the power-spectrum estimation unit 12 outputs the target signal sₖ(f, t) optimized as explained above (step S12). The convolutional-separation-filter estimation unit 13 outputs the convolutional separation filter P(f) optimized as explained above (step S15).

### Characteristics of this Embodiment

In this embodiment, since the model using the convolutional separation combined filter of the rear reverberation removal filter and the sound source separation filter is used, it is possible to perform, at high speed, sound source extraction robust against reverberation in addition to noise. The processing explained above can be executed by real-time processing.

### Second Embodiment

Subsequently, a second embodiment is explained. When the number of target sound sources K is 1, a convolutional separation filter can be optimized at higher speed. This scheme is explained in the second embodiment. The second embodiment is different from the first embodiment in limitation to K=1 and an optimization procedure of the convolutional separation filter. In the following explanation, differences from the matters explained above are mainly explained and the matters explained above are denoted by the same reference numbers and processing is simplified.

[Configuration]

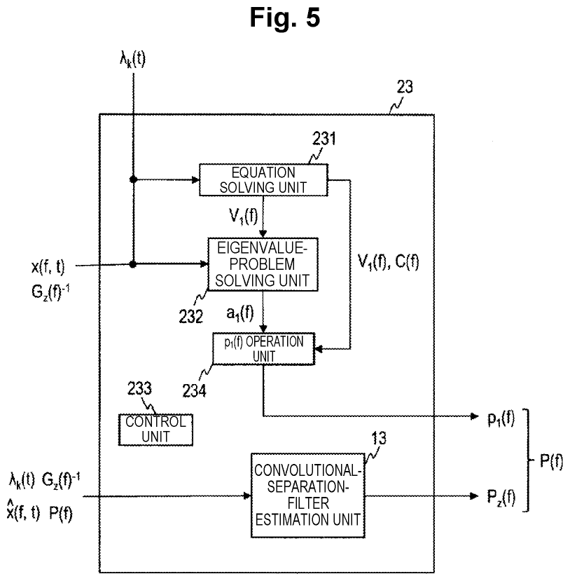

As illustrated in FIG. 1, a signal processing device 2 in the second embodiment includes an initial setting unit 21, the power-spectrum estimation unit 12, a convolutional-separation-filter estimation unit 23, and the control unit 14. The signal processing device 2 executes respective kinds of processing under control by the control unit 14. As illustrated in FIG. 5, the convolutional-separation-filter estimation unit 23 in the second embodiment includes the convolutional-separation-filter estimation unit 13, an equation solving unit 231, an eigenvalue-problem solving unit 232, a p₁(f) operation unit 234, and a control unit 233. The convolutional-separation-filter estimation unit 23 executes respective kinds of processing under control by the control unit 233.

<Processing>

In this embodiment as well, the signal processing device 2 estimates model parameters of a model for applying the convolutional separation filter P(f) to a mixed acoustic signal string x\hat{ }(f, t) including a mixed acoustic signal x(f, t) and a delay signal x(f, t−τ₁), . . . , x(f, t-T_{|Δ|}) of the mixed acoustic signal and obtaining information corresponding to signals in which a rear reverberation component is suppressed and target signals sₖ(f, t) emitted from target sound sources among source signals are emphasized. Processing is explained in detail below.

<<Processing of the Initial Setting Unit 21 (Step S21)>>

As illustrated in FIG. 3, a mixed acoustic signal x(f, t) (f∈{1, . . . , F}, t∈{1, . . . , T}) is input to the initial setting unit 21 of the signal processing device 2. The initial setting unit 21 sets, about all f, any initial values in the separation filter P(f). The initial setting unit 21 calculates x\hat{ }(f, t) according to Expression (14b). Further, the initial setting unit 21 calculates, about all f, G_{z}(f) according to Expression (24). Further, the initial setting unit 21 calculates, about all f, G_{z}(f)⁻¹∈C^{(m+L)×(m+L)} according to Expression (24). The initial setting unit 21 extracts a submatrix V_{z}(f) of M×M at the head of G_{z}(f)⁻¹. The initial setting unit 21 outputs x\hat{ }(f, t) and P(f) to the power-spectrum estimation unit 12 and outputs x\hat{ }(f, t), P(f), G_{z}(f)⁻¹, and V_{z}(f) to the convolutional-separation-filter estimation unit 13 (step S21).

<<Processing of the Power-Spectrum Estimation Unit 12 (Step S12)>>

As explained in the first embodiment, the power-spectrum estimation unit 12 estimates the power spectrum λₖ(t) of target signals sₖ(f, t) with the convolutional separation filter P(f) fixed. The power-spectrum estimation unit 12 outputs the power spectrum λₖ(t) to the convolutional-separation-filter estimation unit 23 (step S12).

<<Processing of the Convolutional-Separation-Filter Estimation Unit 23 (Step S23)>>

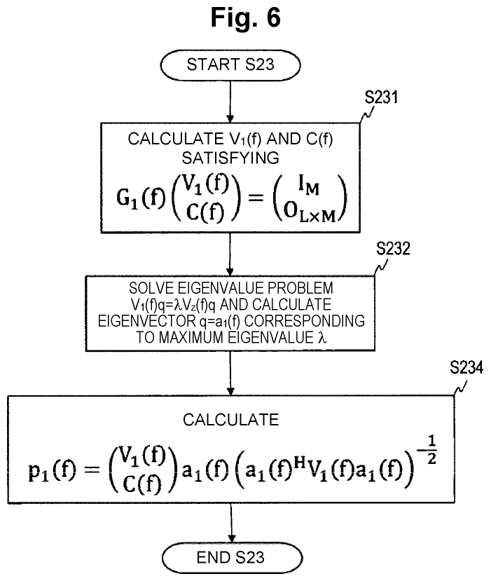

The convolutional-separation-filter estimation unit 23 estimates, with the power spectrum λₖ(t) of the target signals sₖ(f, t) fixed, for each of frequencies, a convolutional separation filter P(f) for optimizing (minimizing) a target function J_{p(f)} (Expression (22)) for the mixed acoustic signal xₖ(f, t) at the frequencies (f∈{1, . . . , F}). For example, as illustrated in FIG. 6, the convolutional-separation-filter estimation unit 23 updates P(f) about all f. The updated P(f) is output to the power-spectrum estimation unit 12.

Update processing of P(f) (FIG. 6):

The equation solving unit 231 uses x\hat{ }(f, t) and λ₁(t) and obtains, about all f, G₁(f) according to Expression (23). Further, th equation solving unit 231 calculates, about all f, an M×M matrix V₁ (f) EC^{M×M} and an L×M matrix C(f)∈C^{L×M} satisfying an equation of Expression (28) and outputs the M×M matrix V₁ (f) ∈C^{M×M} and the L×M matrix C(f)∈C^{L×M}.

[Math. 21]

G₁(f)(^{V}^{₁}^{^{(f)}}_{C(f)})=(_{O}_{_{L×M}}^{I}^{_{M}}) (28)

The M×M matrix V₁(f) is output to the eigenvalue-problem solving unit 232 and the p₁(t) operation unit 234 and the L×M matrix C(f) is output to the p₁(t) operation unit 234 (step S231).

The eigenvalue-problem solving unit 232 takes V₁(f) and V_{z}(f) as an input, solves, about all f, a generalized eigenvalue problem V₁(f)q=λV_{z}(f)q, obtains an eigenvector q=a₁(f) corresponding to a maximum eigenvalue λ, and outputs the eigenvector q=a₁(f). The eigenvector q=a₁(f) is output to the p₁(t) operation unit 234 (step S232).

The p₁(t) operation unit 234 takes V₁(f), a₁(f), and C(f) as an input and calculates, about all f, a target signal p₁(f) according to Expression (29) and outputs the target signal p₁(f) (step S234).

$${p}_{1} ( f ) = ( \begin{matrix}{V}_{1} ( f ) \\ C ( f )\end{matrix} ) {a}_{1} ( f ) {( {{a}_{1} ( f )}^{H} {V}_{1} ( f ) {a}_{1} ( f ) )}^{- \frac{1}{2}} \qquad [ Math . 22 ]$$

<<Processing of the Control Unit 14 (Step S14)>>

The control unit 14 determines whether a predetermined condition is satisfied. When the predetermined condition is not satisfied, the control unit 14 returns the processing to step S12. On the other hand, when the predetermined condition is satisfied, the control unit 14 advances the processing to step S25.

In step S25, first, the convolutional-separation-filter estimation unit 13 of the convolutional-separation-filter estimation unit 23 obtains P_{z}(f) about all f and outputs P_{z}(f) as explained in the first embodiment. Further, for all f and k, the power-spectrum estimation unit 12 outputs the target signal sₖ(f, t) optimized as explained above (step S12). The convolutional-separation-filter estimation unit 23 outputs the convolutional separation filter P(f)=[p₁(f), P_{z}(f)] optimized as explained above (step S25).

### Modification of the Second Embodiment

The eigenvalue-problem solving unit 232 may obtain an eigenvector q=a₁(f) corresponding to the maximum eigenvalue λ in step S232 according to the following Expression (30).

$$\begin{matrix}[ Math . 23 ] & \\ {a}_{1} ( f ) ∈ {{V}_{z} ( f )}^{- 1} {argmax}_{q} \frac{{q}^{H} {{V}_{z} ( f )}^{- 1} q}{{q}^{H} {{V}_{1} ( f )}^{- 1} q} & ( 30 )\end{matrix}$$

where, inverse matrixes V_{z}⁻¹ and V₁⁻¹ of V_{z} and V₁ can be respectively considered covariance matrixes of a mixed acoustic signal string and a noise signal string after removal of the influence of reverberation. Therefore, processing by Expression (32) can be grasped as steering vector estimation based on MaxSNR. Step S234 is equivalent to calculation of a convolutional beam former. Therefore, IVE_{conv} by the convolutional-separation-filter estimation unit 23 is considered to be equivalent to repetition of the steering vector estimation based on MaxSNR and sound source extraction by the convolutional beam former.

### Third Embodiment

In a third embodiment, a sum dₖ(f, t) of a direct sound component and an initial reflection component of the target signal sₖ(f, t) is obtained from the target signal sₖ(f, t) and the convolutional separation filter P(f) optimized in the first and second embodiments or the modification of the second embodiment and is output.

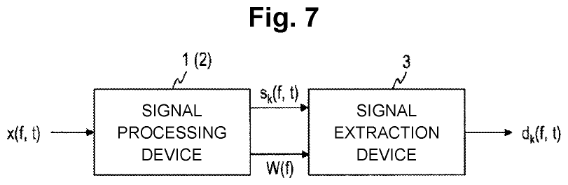

As illustrated in FIG. 7, a system in the third embodiment includes the signal processing device 1 (2) in the first and second embodiments or the modification of the second embodiment and a signal extraction device 3. As explained above, the signal processing device 1 (2) takes the mixed acoustic signal x(f, t) as an input and outputs the target signal sₖ(f, t) and the convolutional separation filter P(f) optimized as explained above.

The signal extraction device 3 takes, as inputs, the optimized target signal sₖ(f, t) and the optimized convolutional separation filter P(f) and obtains, about all k, f, and t, dₖ(f, t) according to the following Expression (31) and outputs dₖ(f, t).

[Math. 24]

dₖ(f,t)=(W(f)^{-H}eₖ)sₖ(f,t) (31)

Thereafter, the obtained dₖ(f, t) may be used in other processing in a time-frequency domain or may be converted into a time domain.

[Experiment]

In an experiment, performance evaluation of four methods written in Table 1 was performed. In Table 1, (a) is a conventional method described in “N. Ono, Proc. WASPAA, pp. 189-192, 2011” (reference document 1), (b) is a conventional method described in “R. Scheibler and N. Ono, arXiv preprint arXiv:1910. 10654, 2019” (reference document 2), and (c) is a conventional method based on “T. Yoshioka and T. Nakatani, IEEE Trans. ASLP, vol. 20, no. 10, pp. 2707-2720, 2012” (reference document 3). However, (c) is alternate optimization of WPE and IVA and is a method obtained by increasing speed of alternate optimization of WPE and ICA (IVA) proposed in the reference document 3. Experiment conditions are as shown in Table 2. Note that RTF represents processing speed. In (a) and (c), among M (>K) outputs, K outputs having large power were selected as a sound source extraction result and SDR/SIR was calculated. Effectiveness of the method of this embodiment was successfully confirmed from Table 1.

TABLE 1

| | | Number of sound sources K/evaluation indicator | | | | | |
|---|---|---|---|---|---|---|---|
| | | K = 1/SDR [dB] | | | K = 2/SIR [dB] | | |
| | | Optimization method (number of times of repetition) | | | | | |
| | | IP-2 | | | IP-1 | | |
| | | (repeated five times) | | | (repeated eight times) | | |
| Number of microphones M | | 4 | 6 | 8 | 4 | 6 | 8 |
| Mixed acoustic | Extraction | 0.0 | 0.0 | 0.0 | 0.0 | 0.0 | 0.0 |
| signal | performance | | | | | | |
| | RTF | 0 | | | 20 | | |
| (a)IVA[1] | Extraction | 2.4 | 2.4 | 0.7 | 27 | 32 | 34 |
| | performance | | | | | | |
| | RTF | 0.16 | 0.33 | 0.61 | 0.43 | 1.09 | 2.13 |
| (b)IVEᵢₙₛₜ[2] | Extraction | 3.7 | 5.0 | 6.0 | 23 | 30 | 33 |
| | performance | | | | | | |
| | RTF | 0.05 | 0.08 | 0.13 | 0.32 | 0.50 | 0.73 |
| (c)WPE⇔IVA[3] | Extraction | 2.3 | 2.2 | 0.4 | 31 | 39 | 44 |
| (Δ = {2}) | performance | | | | | | |
| | RTF | 0.30 | 0.73 | 1.47 | 1.13 | 3.16 | 7.01 |
| (d)This | Extraction | 4.3 | 5.7 | 6.4 | 34 | 40 | 40 |
| embodiment | performance | | | | | | |
| (Δ = {2}) | RTF | 0.11 | 0.18 | 0.29 | 0.65 | 1.19 | 1.96 |

TABLE 2

| | |
|---|---|
| Mixed acoustic | K + 5 Impulse responses (RIR) were respectively |
| signal | convoluted in K target signals (sound signals of point |
| | sound sources) and five noise signals (point sound |
| | sources) and obtained sound images were added up to |
| | create ten samples in total. |
| RIR | RIR of a convolution room JR1 (RT60 = 600 ms) |
| | provided by an RWCP real environment sound/acoustic |
| | database was used. |
| Target signal | CMU ARCTIC Concatenated 15 s |
| Noise signal | Un-overlapping five sections were segmented from |
| | background noise (CAF, CH-1) provided by CHiME-3 |
| | and were used as point sound sources. |
| STFT | Window length: 4096 (256 ms, 16 kHz), frame shift: ¼ |
| Evaluation | SDR/SIR between a signal (a reference signal) obtained |
| indicator | by convoluting RIR cut off to 256 ms in a sound signal |
| | and an emphasized signal dk was measured. |

[Hardware Configuration]

The signal processing devices 1 and 2 and the signal extraction device 3 in the embodiments are devices composed of a general-purpose or dedicated computer including a processor (a hardware processor) such as a CPU (central processing unit) and a memory such as a RAM (random-access memory) or a ROM (read-only memory) executing a predetermined program. The computer may include one processor and one memory or may include a plurality of processors and a plurality of memories. The program may be installed in the computer or may be recorded in the ROM or the like in advance. A part or all of processing units may be configured using not an electronic circuitry into which a program is read to realize a functional configuration like the CPU but an electronic circuitry that independently realizes a processing function. An electronic circuitry configuring one device may include a plurality of CPUs.

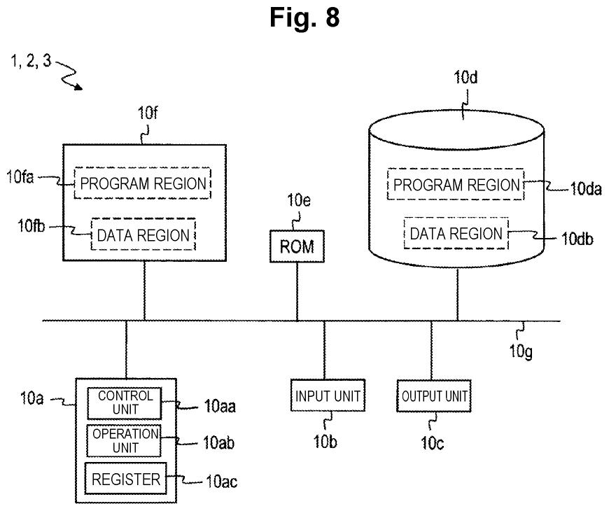

FIG. 8 is a block diagram illustrating a hardware configuration of the signal processing devices 1 and 2 and the signal extraction device 3 in the embodiments. As illustrated in FIG. 8, the signal processing devices 1 and 2 in this example includes a CPU (Central Processing Unit) 10a, an input unit 10b, an output unit 10c, a RAM (Random Access Memory) 10d, a ROM (Read Only Memory) 10e, an auxiliary storage device 10f, and a bus 10g. The CPU 10a in this example includes a control unit 10aa, an operation unit 10ab, and a register 10ac and executes various arithmetic processing according to various programs read into the register 10ac. The input unit 10b is an input terminal to which data is input, a keyboard, a mouse, a touch panel, or the like. The output unit 10c is an output terminal from which data is output, a display, a LAN card controlled by the CPU 10a that reads a predetermined program, or the like. The RAM 10d is an SRAM (Static Random Access Memory), a DRAM (Dynamic Random Access Memory), or the like and includes a program region 10da in which a predetermined program is stored and a data region 10db in which various data are stored. The auxiliary storage device 10f is, for example, a hard disk, an MO (Magneto-Optical disc), or a semiconductor memory and includes a program region 10fa in which a predetermined program is stored and a data region 10fb in which various data are stored. The bus 10g connects the CPU 10a, the input unit 10b, the output unit 10c, the RAM 10d, the ROM 10e, and the auxiliary storage device 10f to be capable of exchanging information. The CPU 10a writes, according to a read OS (Operating System) program, in the program region 10da of the RAM 10d, the program stored in the program region 10fa of the auxiliary storage device 10f. Similarly, the CPU 10a writes, in the data region 10db of the RAM 10d, the various data stored in the data region 10fb of the auxiliary storage device 10f. Addresses on the RAM 10d in which the program and the data are written are stored in the register 10ac of the CPU 10a. The control unit 10aa of the CPU 10a sequentially reads out the addresses stored in the register 10ac, reads out the program and the data from regions on the RAM 10d indicated by the read-out addresses, sequentially causes the operation unit 10ab to execute arithmetic operations indicated by the program, and stores results of the arithmetic operations in the register 10ac. Functional configurations of the signal processing devices 1 and 2 and the signal extraction device 3 are realized by such a configuration.

The program explained above can be recorded in a computer-readable recording medium. An example of the computer-readable recording medium is a non-transitory recording medium. Examples of such a recording medium are a magnetic recording device, an optical disk, a magneto-optical recording medium, a semiconductor memory, and the like.

Distribution of the program is performed by, for example, selling, transferring, or lending a portable recording medium such as a DVD or a CD-ROM recording the program. Further, the program may be stored in a storage device of a server computer and distributed by being transferred from the server computer to other computers via a network. As explained above, first, the computer that executes such a program once stores, in a storage device of the computer, the program recorded in the portable recording medium or the program transferred from the server computer. At an execution time of processing, the computer reads the program stored in the storage device of the computer and executes processing conforming to the read program. As another execution form of the program, the computer may directly read the program from the portable recording medium and execute the processing conforming to the program. Further, every time the program is transferred to the computer from the server computer, the computer may sequentially execute processing conforming to the received program. The transfer of the program from the server computer to the computer may not be performed. The processing explained above may be executed by a service of a so-called ASP (Application Service Provider) type for realizing a processing function according to only an instruction for the execution and acquisition of a result. Note that the program in this embodiment includes information served for processing by an electronic computer and equivalent to the program (data or the like that is not a direct command to the computer but has a characteristic of specifying processing of the computer).

In the embodiments, the devices are configured by causing the computer to execute the predetermined programs. However, at least a part of processing content of the devices may be realized in a hardware manner.

Note that the present invention is not limited to the embodiments explained above. For example, the various kinds of processing explained above may be not only executed in time series according to the description but also executed in parallel or individually according to processing abilities of the devices that execute the processing or according to necessity. Besides, it goes without saying that changes are possible as appropriate in a range not departing from the gist of the present invention.

### REFERENCE SIGNS LIST

1, 2 Signal processing device

1. A signal processing device comprising a processor configured to execute a method comprising:
applying a convolutional separation filter, the applying convolutional separator filter further comprises:
suppressing a rear reverberation component from a mixed acoustic signal obtained by converting an observed mixed acoustic signal obtained by observing a source signal into a time-frequency domain;
emphasizing components corresponding to source signals from the mixed acoustic signal, to a mixed acoustic signal string including the mixed acoustic signal and a delay signal of the mixed acoustic signal; and
estimating model parameters of a model for obtaining information corresponding to signals in which the rear reverberation component is suppressed and target signals emitted from target sound sources in the source signal are emphasized.

2. The signal processing device according to claim 1, wherein
the observed mixed acoustic signal is obtained by observing, with M microphones, the source signals emitted from M sound sources,
the source signals include target signals emitted from K target sound sources,
M includes an integer equal to or larger than 2, K includes an integer equal to or larger than 1 and 1≤K≤M−1,
the mixed acoustic signal includes x(f, t),
f represents an index of a discrete frequency, f∈{1, . . . , F}, and F includes a positive integer,
t is an index of a discrete time, t∈{1, . . . , T}, and T is a positive integer,
the convolutional separation filter includes p₁(f), . . . , p_{K}(f),
pₖ(f)=Q(f)wₖ(f) is a convolutional separation filter component corresponding to a target signal emitted from a k-th target sound source, k∈{1, . . . , K}, and wₖ(f) is the sound source separation filter for emphasizing a component corresponding to the target signal emitted from the k-th target sound source,
$$Q ( f ) := [ \begin{matrix}{I}_{M} \\ - {Q}_{{τ}_{1}} ( f ) \\ ⋮ \\ - {Q}_{τ \vert Δ \vert} ( f )\end{matrix} ] \qquad [ Math . 25 ]$$
I_{α} is a unit matrix of α×α, Q_{δ}(f) is the rear reverberation removal filter, δ∈Δ, Δ∈{τ₁, . . . , τ_{|Δ|}} and |Δ| is a positive integer,
the mixed acoustic signal string is
$$\hat{x} ( f , t ) := [ \begin{matrix}x ( f , t ) \\ x ( f , t - {τ}_{1} ) \\ ⋮ \\ x ( f , t - {τ}_{\vert Δ \vert} )\end{matrix} ] \qquad [ Math . 26 ]$$
the target signals include
[Math. 27]
sₖ(f,t)=pₖ(f)^{H}\hat{x}(f, t)
, and
α^{H} is Hermitian transposition of α.

3. The signal processing device according to claim 2, wherein
the source signals further include noise signals emitted from M−K noise sources,
the convolutional separation filter further includes P_{z}(f),
P_{z}(f)=Q(f)W_{z}(f) is a convolutional separation filter component corresponding to a noise signal emitted from a noise source, and W_{z}(f) is the sound source separation filter for emphasizing a component corresponding to the noise signal emitted from the noise source,
information corresponding to the noise signals is
[Math. 28]
z(f,t)=P_{z}(f)^{H}\hat{x}(f,t)
sₖ(t)˜CN(0_{F},λₖ(t)IF) and
z(f,t)˜CN(0_{M-K},I_{M-K}),
sₖ(t):=[sₖ(1, t), . . . , sₖ(F,t)]^{T}, λₖ(t) is a power spectrum of sₖ(t), α^{T} is transposition of α, CN(μ, Σ) is a complex normal distribution of a distributed covariance matrix Σ in an average vector μ, 0_{α} is an α-dimensional vector, all elements of which are 0, and β˜CN(μ, Σ) represents that β conforms to the complex normal distribution CN(μ, Σ),
[Math. 29]
p({sₖ(t),z(f,t)}_{k,f,t})=Π_{k,t}sₖ(t)·Π_{f,t}z(f,t)
, and
p(α) is a probability of occurrence of α.

4. The signal processing device according to claim 3, the processor is further configured to execute a method comprising:
obtaining a power spectrum of sₖ(t)
$${λ}_{k} ( t ) = \frac{1}{F} {‖ {s}_{k} ( t ) ‖}^{2} \qquad [ Math . 30 ]$$
with the convolutional separation filter P(f)=[p₁(f), . . . , pₖ(f), P_{z}(f)] fixed;
obtaining, for each of frequencies, the convolutional separation filter P(f) for minimizing a target function
[Math. 31]
∫_{P(f)}=Σₖ₌₁^{K}Pₖ(f)^{H}Gₖ(f)Pₖ(f)+tr(P_{z}(f)^{H}G_{z}(f)P_{z}(f))−2 log|detW(f)|

for the mixed acoustic signal x(f, t) at the frequencies corresponding to f with power spectrum λₖ(t) of the target signals fixed; and
alternately executing the obtaining a power spectrum and the obtaining, for each of frequencies, the convolutional separation filter P(f) until a predetermined condition is satisfied, wherein
$${G}_{k} ( f ) = \frac{1}{T} {\sum }_{t = 1}^{T} \frac{\hat{x} ( t , f ) {\hat{x} ( t , f )}^{H}}{{λ}_{k} ( t , f )} \qquad [ Math . 32 ]$$
$${G}_{z} ( f ) = \frac{1}{T} {\sum }_{t = 1}^{T} \hat{x} ( t , f ) {\hat{x} ( t , f )}^{H} \qquad [ Math . 33 ]$$
first M row components of the convolutional separation filter P(f) is W(f):=[w₁(f), . . . , w_{K}(f), W_{z}(f)], and
tr(α) is a diagonal partial sum of α, and det(α) is a determinant of α.

5. The signal processing device according to claim 4, wherein
α^{-H} is Hermitian transposition of an inverse matrix of α, eₖ is an M-dimensional unit vector, a k-th component of which is 1, E_{z}:=[e_{K+1}, . . . , e_{M}], Eₛ:=[e₁, . . . , eₖ], Wₛ(f):=[w₁(f), . . . , w_{K}(f)], and 0_{α×β} is an α×β matrix, all elements of which is 0,
the processor further configured to execute a method comprising:
obtaining, about k=1, . . . , K,
$${q}_{k} ( f ) = {{G}_{k} ( f )}^{- 1} ( \begin{matrix}{W ( f )}^{- H} {e}_{k} \\ {0}_{L}\end{matrix} ) \qquad [ Math . 34 ]$$
$$and$$
$${p}_{k} ( f ) = {q}_{k} ( f ) {( {{q}_{k} ( f )}^{H} {G}_{k} ( f ) {q}_{k} ( f ) )}^{- \frac{1}{2}} ; \qquad [ Math . 35 ]$$
and
obtaining
$${P}_{z} ( f ) = {{G}_{z} ( f )}^{- 1} ( \begin{matrix}{( {{W}_{s} ( f )}^{H} {E}_{s} )}^{- 1} ( {{W}_{s} ( f )}^{H} {E}_{z} ) \\ - {I}_{M - K} \\ {O}_{L ⨯ ( M - K )}\end{matrix} ) . \qquad [ Math . 36 ]$$

6. The signal processing device according to claim 4, wherein
K=1,
0_{L×M} is a L×M matrix, all elements of which are 0,
V₁(f) is a submatrix of M×M at a head of G₁(f)⁻¹,
V_{z}(f) is a submatrix of M×M at a head of G_{z}(f)⁻¹, and
the processor further configured to execute a method comprising:
obtaining an M×M matrix V₁(f) and an L×M matrix C(f) satisfying
[Math. 37]
G₁(f)_{(C(f)}^{V}^{₁}^{^{(f)}})=(O_{L×M}^{I}^{_{M}}); and
computing an eigenvalue problem V₁(f)q=λV_{z}(f)q to obtain an eigenvector q=a₁(f) corresponding to a maximum eigenvalue λ; and
obtaining
$${p}_{1} ( f ) = ( \begin{matrix}{V}_{1} ( f ) \\ C ( f )\end{matrix} ) {a}_{1} ( f ) {( {{a}_{1} ( f )}^{H} {V}_{1} ( f ) {a}_{1} ( f ) )}^{- \frac{1}{2}} . \qquad [ Math . 38 ]$$

7. The signal processing device according to claim 6, the processor further configured to execute a method comprising:
obtaining the eigenvector q=a₁(f) according to
$${a}_{1} ( f ) ∈ {{V}_{z} ( f )}^{- 1} {arg max}_{q} \frac{{q}^{H} {{V}_{z} ( f )}^{- 1} q}{{q}^{H} {{V}_{1} ( f )}^{- 1} q} . \qquad [ Math . 39 ]$$

8. The signal processing device according to claim 1, wherein
the model parameters include power spectra of the target signals and the convolutional separation filter, and
the signal processing device comprises the processor further configured to execute a method comprising:
estimating the power spectra of the target signals with the convolutional separation filter fixed;
estimating, with the power spectra of the target signals fixed, for each of frequencies, the convolutional separation filter for optimizing a target function for the mixed acoustic signal at the frequencies; and
alternately executing the estimating the power spectra and estimating, with the power spectra of the target signals fixed, for each of frequencies, the convolutional separation filter until a predetermined condition is satisfied.

9. A signal processing method for applying a convolutional separation filter, comprising:
suppressing a rear reverberation component from a mixed acoustic signal obtained by converting an observed mixed acoustic signal obtained by observing a source signal into a time-frequency domain; and
emphasizing components corresponding to source signals from the mixed acoustic signal, to a mixed acoustic signal string including the mixed acoustic signal and a delay signal of the mixed acoustic signal; and
estimating model parameters of a model for obtaining information corresponding to signals in which the rear reverberation component is suppressed and target signals emitted from target sound sources in the source signal are emphasized.

10. A computer-readable non-transitory recording medium storing computer-executable program instructions that when executed by a processor cause a computer to execute a method for signal processing, comprising:
applying a convolutional separation filter, the applying convolutional separator filter further comprises:
suppressing a rear reverberation component from a mixed acoustic signal obtained by converting an observed mixed acoustic signal obtained by observing a source signal into a time-frequency domain;
emphasizing components corresponding to source signals from the mixed acoustic signal, to a mixed acoustic signal string including the mixed acoustic signal and a delay signal of the mixed acoustic signal; and
estimating model parameters of a model for obtaining information corresponding to signals in which the rear reverberation component is suppressed and target signals emitted from target sound sources in the source signal are emphasized.

11. The signal processing method according to claim 9, wherein
the observed mixed acoustic signal is obtained by observing, with M microphones, the source signals emitted from M sound sources,
the source signals include target signals emitted from K target sound sources,
M is an integer equal to or larger than 2, K is an integer equal to or larger than 1 and 1≤K≤M−1,
the mixed acoustic signal is x(f, t),
f is an index of a discrete frequency, f∈{1, . . . , F}, and F is a positive integer,
t is an index of a discrete time, t∈{1, . . . , T}, and T is a positive integer,
the convolutional separation filter includes p₁(f), . . . , p_{K}(f),
pₖ(f)=Q(f)wₖ(f) is a convolutional separation filter component corresponding to a target signal emitted from a k-th target sound source, k∈{1, . . . , K}, and wₖ(f) is the sound source separation filter for emphasizing a component corresponding to the target signal emitted from the k-th target sound source,
$$Q ( f ) := [ \begin{matrix}{I}_{M} \\ - {Q}_{{τ}_{1}} ( f ) \\ ⋮ \\ - {Q}_{{τ}_{\vert Δ \vert}} ( f )\end{matrix} ] \qquad [ Math . 25 ]$$
I_{α} is a unit matrix of α×α, Q_{δ}(f) is the rear reverberation removal filter, δ∈Δ, Δ∈{τ₁, . . . , τ_{|Δ|}}, and |Δ| is a positive integer,
the mixed acoustic signal string is
$$\hat{x} ( f , t ) := [ \begin{matrix}x ( f , t ) \\ x ( f , t - {τ}_{1} ) \\ ⋮ \\ x ( f , t - {τ}_{\vert Δ \vert}\end{matrix} ] \qquad [ Math . 26 ]$$
the target signals include
[Math. 27]
sₖ(f,t)=Pₖ(f)^{H}\hat{x}(f,t)
, and
α^{-H} is Hermitian transposition of α.

12. The signal processing method according to claim 11, wherein
the source signals further include noise signals emitted from M−K noise sources,
the convolutional separation filter further includes P_{z}(f),
P_{z}(f)=Q(f)W_{z}(f) is a convolutional separation filter component corresponding to a noise signal emitted from a noise source, and W_{z}(f) is the sound source separation filter for emphasizing a component corresponding to the noise signal emitted from the noise source,
information corresponding to the noise signals is
[Math. 28]
z(f,t)=P_{z}(f)^{H}\hat{x}(f,t)
sₖ(t)˜CN(0_{F},λₖ(t)I_{F}) and
z(f,t)˜CN(0_{M-K}, I_{M-K}),
sₖ(t):=[sₖ(1, t), . . . , sₖ(F, t)]^{T}, λₖ(t) is a power spectrum of sₖ(t), α^{T} is transposition of α, CN(μ, Σ) is a complex normal distribution of a distributed covariance matrix Σ in an average vector μ, 0_{α} is an α-dimensional vector, all elements of which are 0, and β˜CN(μ, Σ) represents that β conforms to the complex normal distribution CN(μ, Σ),
[Math. 29]
p({sₖ(t),z(f,t)}_{k,f,t})=Π_{k,t}sₖ(t)·Π_{f,t}z(f,t)
, and
p(α) is a probability of occurrence of α.

13. The signal processing method according to claim 12, further comprising:
obtaining a power spectrum of sₖ(t)
$${λ}_{k} ( t ) = \frac{1}{F} {‖ {s}_{k} ( t ) ‖}^{2} \qquad [ Math . 30 ]$$
with the convolutional separation filter P(f)=[p₁(f), . . . , pₖ(f), P_{z}(f)] fixed;
obtaining, for each of frequencies, the convolutional separation filter P(f) for minimizing a target function
[Math. 31]
∫P(f)=Σₖ₌₁^{K}Pₖ(f)^{H}Gₖ(f)Pₖ(f)+tr(P_{z}(f)^{H}G_{z}(f)P_{z}(f))−2 log|detW(f)|

for the mixed acoustic signal x(f, t) at the frequencies corresponding to f with power spectrum λₖ(t) of the target signals fixed; and
alternately executing the obtaining a power spectrum and the obtaining, for each of frequencies, the convolutional separation filter P(f) until a predetermined condition is satisfied, wherein
$${G}_{k} ( f ) = \frac{1}{T} {\sum }_{t = 1}^{T} \frac{\hat{x} ( t , f ) {\hat{x} ( t , f )}^{H}}{{λ}_{k} ( t , f )} \qquad [ Math . 32 ]$$
$${G}_{z} ( f ) = \frac{1}{T} {\sum }_{t = 1}^{T} \hat{x} ( t , f ) {\hat{x} ( t , f )}^{H} \qquad [ Math . 33 ]$$
first M row components of the convolutional separation filter P(f) is W(f):=[w₁(f), . . . , w_{K}(f), W_{z}(f)], and
tr(α) is a diagonal partial sum of α, and det(α) is a determinant of α.

14. The signal processing method according to claim 13, wherein
α^{-H} is Hermitian transposition of an inverse matrix of α, eₖ is an M-dimensional unit vector, a k-th component of which is 1, E_{z}:=[eₖ₊₁, . . . , e_{M}], Eₛ:=[e₁, . . . , e_{K}], Wₛ(f):=[w₁(f), . . . , w_{K}(f)], and 0_{α×β} is an α×β matrix, all elements of which is 0,
the processor further configured to execute a method comprising:
obtaining, about k=1, . . . , K,
[Math. 34]
qₖ(f)=Gₖ(f)⁻¹(^{W(f)}^{^{−H}}^{_{c}}^{ₖ}₀_{_{L}})
and
$${p}_{k} ( f ) = {q}_{k} ( f ) {( {{q}_{k} ( f )}^{H} {G}_{k} ( f ) {q}_{k} ( f ) )}^{- \frac{1}{2}} ; \qquad [ Math . 35 ]$$
and
obtaining
$${P}_{z} ( f ) = {{G}_{z} ( f )}^{- 1} ( \begin{matrix}{( {{W}_{s} ( f )}^{H} {E}_{s} )}^{- 1} ( {{W}_{s} ( f )}^{H} {E}_{z} \\ - {1}_{M - K} \\ {O}_{L ⨯ ( M - K )}\end{matrix} ) . \qquad [ Math . 36 ]$$

15. The signal processing method according to claim 13, wherein
K=1,
01_{L×M} is a L×M matrix, all elements of which are 0,
V₁(f) is a submatrix of M×M at a head of G₁(f)⁻¹,
V_{z}(f) is a submatrix of M×M at a head of G_{z}(f)⁻¹, and
the method further comprising:
obtaining an M×M matrix V₁(f) and an L×M matrix C(f) satisfying
[Math. 37]
G₁(f)(^{V}^{_{1(f)}}_{C(f)})=(_{O}_{_{L×M}}^{I}^{_{M}}); and
computing an eigenvalue problem V₁(f)q=λV_{z}(f)q to obtain an eigenvector q=a₁(f) corresponding to a maximum eigenvalue λ; and
obtaining
$${p}_{1} ( f ) = ( \begin{matrix}{V}_{1} ( f ) \\ C ( f )\end{matrix} ) {a}_{1} ( f ) {( {{a}_{1} ( f )}^{H} {V}_{1} ( f ) {a}_{1} ( f ) )}^{- \frac{1}{2}} . \qquad [ Math . 38 ]$$

16. The signal processing method according to claim 9,
wherein
the model parameters include power spectra of the target signals and the convolutional separation filter, and
the method further comprising:
estimating the power spectra of the target signals with the convolutional separation filter fixed;
estimating, with the power spectra of the target signals fixed, for each of frequencies, the convolutional separation filter for optimizing a target function for the mixed acoustic signal at the frequencies; and
alternately executing the estimating the power spectra and estimating, with the power spectra of the target signals fixed, for each of frequencies, the convolutional separation filter until a predetermined condition is satisfied.

17. The computer-readable non-transitory recording medium according to claim 10, wherein
the observed mixed acoustic signal is obtained by observing, with M microphones, the source signals emitted from M sound sources,
the source signals include target signals emitted from K target sound sources, M is an integer equal to or larger than 2, K is an integer equal to or larger than 1 and 1≤K≤M−1,
the mixed acoustic signal is x(f, t),
f is an index of a discrete frequency, f∈{1, . . . , F}, and F is a positive integer,
t is an index of a discrete time, t∈{1, . . . , T}, and T is a positive integer,
the convolutional separation filter includes p₁(f), . . . , p_{K}(f),
pₖ(f)=Q(f)wₖ(f) is a convolutional separation filter component corresponding to a target signal emitted from a k-th target sound source, k∈{1, . . . , K}, and wₖ(f) is the sound source separation filter for emphasizing a component corresponding to the target signal emitted from the k-th target sound source,
$$Q ( f ) := [ \begin{matrix}{I}_{M} \\ - {Q}_{{τ}_{1}} ( f ) \\ ⋮ \\ - {Q}_{{τ}_{\vert Δ \vert}} ( f )\end{matrix} ] \qquad [ Math . 25 ]$$
I_{α} is a unit matrix of α×α, Q_{δ}(f) is the rear reverberation removal filter, δ∈Δ, Δ∈{τ₁, . . . , τ_{|Δ|}}, and |Δ| is a positive integer,
the mixed acoustic signal string is
$$\hat{x} ( f , t ) := [ \begin{matrix}x ( f , t ) \\ x ( f , t - {τ}_{1} ) \\ ⋮ \\ x ( f , t - {τ}_{\vert Δ \vert}\end{matrix} ] \qquad [ Math . 26 ]$$
the target signals include
[Math. 27]
sₖ(f,t)=pₖ(f)^{H}\hat{x}(f,t)
, and
α is Hermitian transposition of α.

18. The computer-readable non-transitory recording medium according to claim 17,
wherein
the source signals further include noise signals emitted from M−K noise sources,
the convolutional separation filter further includes P_{z}(f),
P_{z}(f)=Q(f)W_{z}(f) is a convolutional separation filter component corresponding to a noise signal emitted from a noise source, and W_{z}(f) is the sound source separation filter for emphasizing a component corresponding to the noise signal emitted from the noise source,
information corresponding to the noise signals is
[Math. 28]
z(f,t)=P_{z}(f)^{H}\hat{x}(f,t)
sₖ(t)˜CN(0_{F}, λₖ(t)I_{F}) and
z(f,t)˜CN(0_{M-K}, I_{M-K}),
sₖ(t):=[sₖ(1, t), . . . , sₖ(F,t)]^{T}, λₖ(t) is a power spectrum of Sₖ(t), α^{T} is transposition of α, CN(μ, Σ) is a complex normal distribution of a distributed covariance matrix Σ in an average vector μ, 0_{α} is an α-dimensional vector, all elements of which are 0, and β˜CN(μ, Σ) represents that β conforms to the complex normal distribution CN(μ, Σ),
[Math. 29]
p({sₖ(t),z(f,t)}_{k,f,t})Π_{k,t}sₖ(t)·Π_{f,t}z(f,t)
, and
p(α) is a probability of occurrence of α.

19. The computer-readable non-transitory recording medium according to claim 18, the computer-executable program instructions when executed further causing the computer to execute a method comprising:
obtaining a power spectrum of sₖ(t)
$${λ}_{k} ( t ) = \frac{1}{F} {‖ {s}_{k} ( t ) ‖}^{2} \qquad [ Math . 30 ]$$
with the convolutional separation filter P(f)=[p₁(f), . . . , pₖ(f), P_{z}(f)] fixed;
obtaining, for each of frequencies, the convolutional separation filter P(f) for minimizing a target function
[Math. 31]
∫_{P(f)}=Σₖ₌₁^{K}Pₖ(f)^{H}Gₖ(f)Pₖ(f)+tr(P_{z}(f)^{H}G_{z}(f)P_{z}(f))−2 log|detW(f)|

for the mixed acoustic signal x(f, t) at the frequencies corresponding to f with power spectrum λₖ(t) of the target signals fixed; and
alternately executing the obtaining a power spectrum and the obtaining, for each of frequencies, the convolutional separation filter P(f) until a predetermined condition is satisfied, wherein
$${G}_{k} ( f ) = \frac{1}{T} {\sum }_{t = 1}^{T} \frac{\hat{x} ( t , f ) {\hat{x} ( t , f )}^{H}}{{λ}_{k} ( t , f )} \qquad [ Math . 32 ]$$
$${G}_{z} ( f ) = \frac{1}{T} {\sum }_{t = 1}^{T} \hat{x} ( t , f ) {\hat{x} ( t , f )}^{H} \qquad [ Math . 33 ]$$
first M row components of the convolutional separation filter P(f) is W(f):=[w₁(f), . . . , w_{K}(f), W_{z}(f)], and
tr(α) is a diagonal partial sum of α, and det(α) is a determinant of α.

20. The computer-readable non-transitory recording medium according to claim 10, wherein
the model parameters include power spectra of the target signals and the convolutional separation filter, and
the computer-executable program instructions when executed further causing the computer to execute a method comprising:
estimating the power spectra of the target signals with the convolutional separation filter fixed;
estimating, with the power spectra of the target signals fixed, for each of frequencies, the convolutional separation filter for optimizing a target function for the mixed acoustic signal at the frequencies; and
alternately executing the estimating the power spectra and estimating, with the power spectra of the target signals fixed, for each of frequencies, the convolutional separation filter until a predetermined condition is satisfied.
